(19) United States
(12) Patent Application Publication
(10) Pub. No.: US 2009/0104512 A1
(43) Pub. Date: Apr. 23, 2009

(54) DEVICE HAVING AT LEAST ONE ELECTROCHEMICAL CELL

(76) Inventors: Jochen Fassnacht, Calw (DE); Richard Aumayer, Dickhohem (DE); Dieter Hanauer, Buedingen (DE)

Correspondence Address: MICHAEL J. STRIKER, 103 EAST NECK ROAD, HUNTINGTON, NY, 11743, US

(21) Appl. No.: 12/297,682

(22) PCT Filed: Dec. 21, 2007
(86) PCT No.: PCT/EP2007/064444

§ 371 Date: Oct. 20, 2008

(30) Foreign Application Priority Data
Jan. 30, 2007 (DE) 10 2007 004 567.2

(51) Int. Cl. H01M 10/50

(52) U.S. Cl. 429/120

(57) ABSTRACT

The invention is based on a device having at least one electrochemical cell (10), which is embodied as essentially flat and has laterally protruding cooling lugs (20, 22) for electrical contacting.

It is proposed that each cell (10) is enclosed between two housing parts (30, 40) that clamp the cell (10) between them with pressure force in at least some regions.

### PRIOR ART

The invention is based on a device having at least one electrochemical cell as generically defined by the preamble to claim 1.

In sophisticated traction systems such as hybrid motor vehicles, powerful electrical reservoirs are needed. Nickel-metal hydride reservoirs are known for this purpose, which are combined, for instance in many modules, each with a plurality of individual cells as a reservoir unit. As an economical and powerful alternative, lithium-ion batteries are known, of the kind described in European Patent Disclosure EP 1 577 973 A1. There, so-called “coffee bag” cells are embodied as rectangular flat cells. In such cells, the electrode packs are located in a lined metal film that conforms to the electrode pack. The cells are correspondingly soft. There are typically combined into a plurality of modules and connected electrically parallel and/or in series. However, these cells must be installed in a suitable cell housing before they can be combined into a module.

Moreover, in certain error states, such as overloading of the cells, the risk of cell destruction exists; the cell can react very strongly in the event of an error and give off a great deal of heat. Such an error in a cell must be prevented from damaging other cells or even leading to a so-called “thermal runaway” that involves other cells along with it.

### DISCLOSURE OF THE INVENTION

The invention is based on a device having at least one electrochemical cell, which is embodied as essentially flat and has laterally protruding cooling lugs for electrical contacting.

It is proposed that each cell is enclosed between two housing parts that clamp the cell between them with pressure force in at least some regions. Advantageously, the cell, particularly in the region of its electrode pack, can experience a large-area pressure. It can thus be prevented that the electrode pack will be separated in operation, which would have consequences ranging from sacrifices in power up to the failure of the cell. During its entire service life, the cell can remain in a compressed state. The two housing parts can be joined together by being clipped together or being welded to one another. The housing parts can be joined for constant spacing or for constant contact pressure. One skilled in the art will select the type of connection that is suited based on the specific conditions of use of the device.

Advantageously, regions that are mechanically especially vulnerable to damage from vibration can be stabilized. The regions where the cooling lugs are extended to the outside, and the cooling lugs themselves, can be relieved of vibration. A welding seam extending along the edge of the cell can also be relieved by pressure. Regions where for safety reasons a break is wanted under certain preconditions, such as a rated breaking point of the cell, can be intentionally recessed out. Such a breaking point can be intentionally excepted from the vibration relief, so as to assure its function.

In a favorable refinement, the cell can be subjected to pressure force on its edge. A typically encompassing weld seam of the cell package can thus be protected. Preferably, both housing parts are constructed symmetrically. However, it is also conceivable for one housing part to have an encompassing bead in the region of the cell edge and the other housing part to have a complementary groove. The tightness of the cell edge welding can thus be reinforced. It is especially favorable if the bead and groove, or in a symmetrical embodiment the bead and the counterpart bead, in the region of the cell edge are embodied outside the point where the cooling lugs emerge. In the region of the cooling lugs, only large-area pressure is effected. Typically, the cooling lugs have a low material thickness that can be pressed into a groove only with difficulty, while the remaining thin encompassing sealing edge can be pressed into the groove, thus creating additional reinforcement of the sealing.

Moreover, the cell can be subjected to pressure force in the region of the cooling lugs, and thus the exit region and the cooling lugs can be stabilized. Preferably, the pressure force in this region is a large-area pressure force.

At least one housing part can have an indentation for receiving the cell. This makes it easier to furnish faces for exerting pressure force. Preferably, both housing parts are embodied symmetrically.

Advantageously, an encompassing edge can be provided, which subjects the cell to pressure force on its edge. Optionally, a recess for a rated breaking point, such as a valve, can be provided. Preferably, both housing parts are embodied symmetrically.

A shoulder can be provided, which subjects a cooling lug to pressure force. Preferably, both housing parts are embodied symmetrically. From the recess for the cell outward, a first step is thus embodied for the peripheral pressing, and a second step is embodied for pressing the exit region of the cooling lugs. For the peripheral pressing, however, it is also possible for a bead to be provided on one housing half and a complementary groove on the other.

In at least one housing part, openings for a cooling medium can be provided. Preferably, both housing parts are embodied symmetrically. The cells are therefore adequately coolable with a cooling medium, preferably air. Advantageously, the cells or modules are easily interchangeable, which is favorable especially when used in relatively large modules in motor vehicles. A defective battery module can therefore easily be repaired or replaced. Moreover, conduits for a cooling medium can be provided for at least housing part.

In a preferred further embodiment, a plurality of encased cells can be stacked on another in a stacking direction and braced against one another. Thus modules can be constructed that have a plurality of individual cells. The cells in turn can be constructed with preferably identical modules to make larger battery units. If one cell is defective, individual cells or individual modules can be replaced easily and economically. To maintain a pressure on the entire cell surface, end plates reinforced at the ends of the stack can be provided, and/or the housing halves of the outer cells can be suitably reinforced. For pressing the encased cells, tie bolts, for instance in the form of threaded rods, can be introduced into suitable bores in the housing halves and screwed in. For replacing individual cells, these bolts can easily be released and screwed back together. In such a stacked arrangement, a separate closure of the housing halves (clipping, welding) can optionally be dispensed with, since the pressure force can be furnished by the tie bolts.

Advantageously, a thermally insulating and/or fire retardant intermediate layer can be inserted between the encased cells. Optionally, the encased cells may be formed of a corresponding material, so that the intermediate layers can be dispensed with. This makes the stack smaller.

Favorably, the cooling lugs can protrude from the housing parts and be connected electrically to one another in series and/or parallel. They can be welded together in an inexpensive variant, or they can be clamped in a clamping device for clamping and electrically contacting the cooling lugs. As a result of the clamping, it is especially easy to replace defective individual cells.

If there is a plurality of encased cells, the cooling lugs can be clamped on both sides of the housing parts in a respective clamping device and, except for one cooling lug of each of the outer cells, at least two cooling lugs on the same side can be joined together in the clamping device. Once again, replacing individual cells can be done in a simple way. However, still more economically, the cooling lugs can also be welded.

Depending on the desired voltage or electrical power, the encased cells can be combined in one or more stacks in a battery packet. An installed position of one or more stacks in the corresponding battery packet can be intrinsically arbitrary; that is, it may be vertical, horizontal, transverse, or the like. For given peripheral conditions, one skilled in the art will select the particular suitable installation position.

The device of the invention is especially suitable for use in hybrid vehicles, in the industrial field, or for applications, such as electrically operated wheelchairs, motorbikes (mopeds) with an auxiliary electrical drive, or forklifts or driverless transport systems.

### BRIEF DESCRIPTION OF THE DRAWINGS

### Drawing

Further advantages will become apparent from the ensuing description of the drawings. In the drawings, exemplary embodiments of the invention are shown. One skilled in the art will expediently consider the characteristics disclosed in the drawings, specification and claims in combination, individually as well, and put them together to make appropriate further combinations.

Shown are:

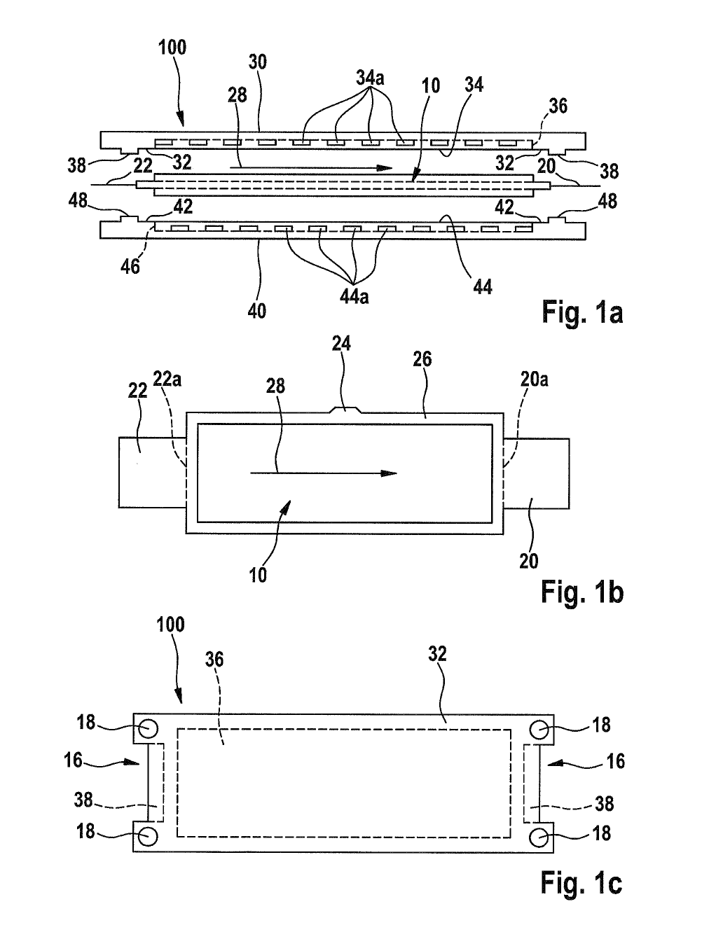

FIGS. 1a-d, a top view on a preferred device, shown in an exploded view, with two housing parts and a cell located between them (FIG. 1a); a side view of a so-called “coffee bag” cell (FIG. 1b); a side view of a preferred housing part (FIG. 1c); and a detail of an alternative embodiment of the housing parts with a bead and groove (FIG. 1d);

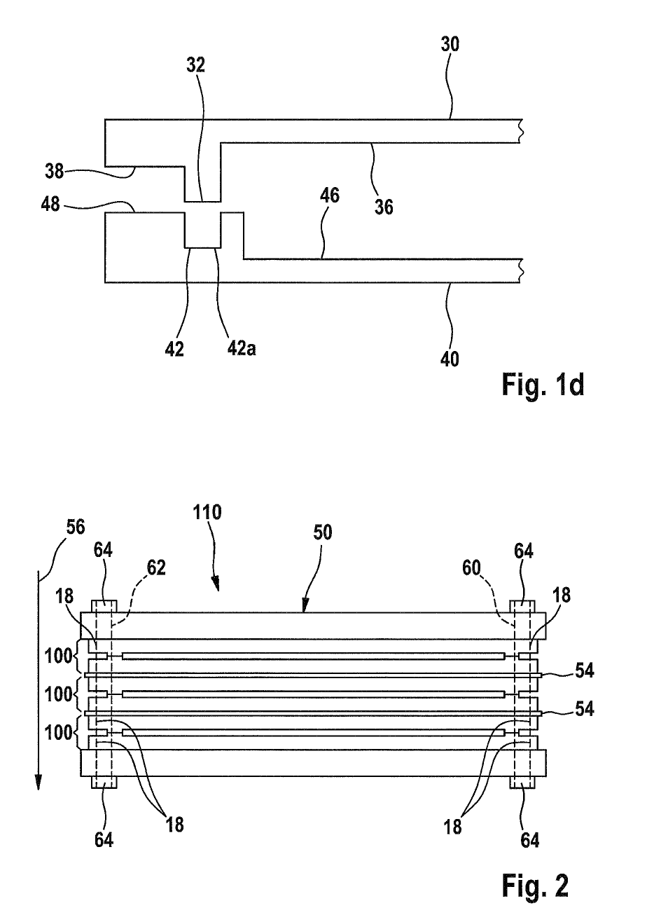

FIG. 2, a top view on a further preferred device, with a stacked assembly of encased cells with reinforced end plates; and

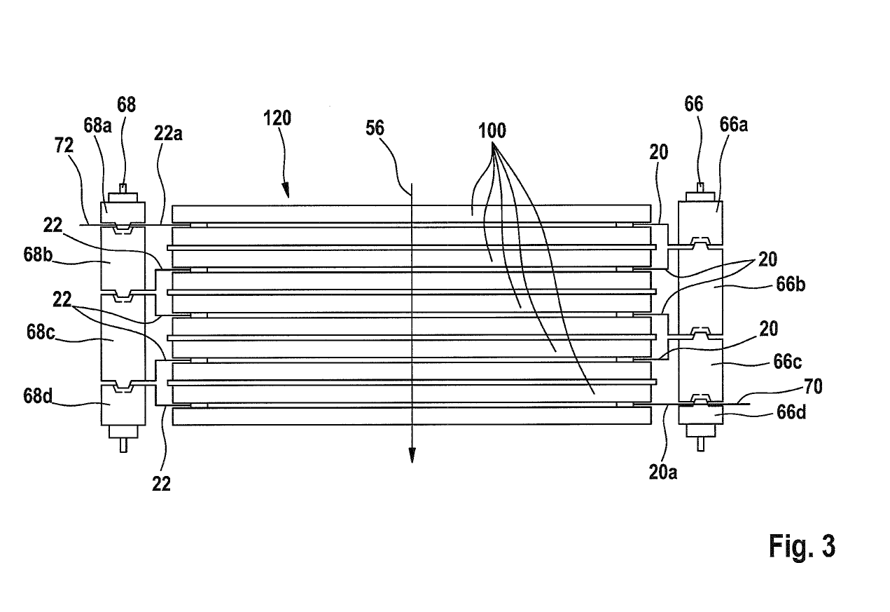

FIG. 3, a top view on a further preferred device, with a stacked assembly of encased cells and with clamping devices for cooling lugs.

### EMBODIMENTS OF THE INVENTION

In the drawings, identical or similar components are identified by the same reference numerals.

For illustrating the invention, FIGS. 1a-1d show various details of a preferred device 100 with an encased cell 10. A top view on the device 100 in exploded form is shown in FIG. 1a. A further housing part 30 and a second housing part 40 enclose a flat electrochemical cell 10, preferably, a lithium-ion cell. The housing parts 30, 40 enclose the cell 10 in clamshell-like fashion.

The cell 10 is embodied as a flat cell, as a so-called “coffee bag” cell (FIG. 1b), and essentially rectangularly, with a length 28. A typical thickness of such a cell 10 is in the range of a few millimeters. Typically, such cells 10 are packed in aluminum foil, which conforms to the electric pack in the interior of the cell 10. Accordingly, the cell 10 is embodied as relatively soft.

A laminated edge 26 is embodied extending all the way around, typically in the range of 1 mm, which seals off the cell 10 from outside. The edge is interrupted at one point with a valve 24 as a rated breaking point. At the edge 26 of the cell 10, one cooling lug 20 and 22 on each side emerges to the outside at openings 20a and 22a, respectively, for instance on short sides along the length 28. The cooling lugs 20, 22 (current conductors) form the electrical poles of the cell 10.

The housing parts 30, 40 in this example are embodied identically. The housing part 30 has a recess 36 in the middle that is adapted to the cell 10 and is surrounded by an edge 32. The edge 32 forms a support for the cell 10, and in the assembled state leads to a pressure force on the edge of the cell 10. In the periphery 34 on the long sides of the housing part 30, openings 34a are embodied, with which a cooling medium, such as air, can be delivered to the cell 10 between the housing parts 30, 40. The openings 34a lead from outside, through the edge 32 that generates the pressure force, to the recess 36 for the cell 10.

On the short sides of the housing part 30, shoulders 38 are embodied, in such a way that in the assembled state, they can exert a pressure force on the cooling lugs 20, 22 of the cell 10. In this way, the cooling lugs 20, 22 and the edge 26 of the cell 10 are relieved of vibration. The housing part 40 is embodied identically to the housing part 30.

The housing part 40 has a recess 46 in the middle, adapted to the cell 10, that is surrounded by an edge 42. The edge 42 forms a support for the cell 10 and in the assembled state with the housing part 30 leads to a pressure force on the edge of the cell 10. In the periphery 44 on the long sides of the housing part 40, openings 44a for the cooling medium are embodied and lead from the outside, through the edge 42 that generates the pressure force, to the recess 46 for the cell 10. On the short sides of the housing part 40, shoulders 48 are embodied, in such a way that in the assembled state, they can exert a pressure force on the cooling lugs 20, 22 of the cell 10. A recess for a safety valve, cell vent, or the like may be provided in the periphery 34 and/or 44.

The housing parts 30, 40 can be joined together in various ways, such as by clipping or welding. The cell 10 placed between them experiences a large-area pressure, preferably in the region of its electrode pack, not shown, in its interior. It can thus be attained that the electrode pack will not separate during the service life of the cell 10 but instead always remains in a compressed state. The cell housing can be joined for either constant spacing or constant contact pressure. The openings 34a, 44a assure that adequate cooling is possible.

A side view of one of the preferred housing parts 30 is shown in FIG. 1c. The housing part 30 is embodied substantially rectangularly, with the recess 36 that is surrounded by the edge 32. On the short sides 16, outside the shoulders 38, bores 18 are made, with which a plurality of such housing parts 30, 40 with installed cells 10 can be screwed together in a simple way, for instance by means of threaded rods.

An alternative embodiment of the housing parts 30, 40 is sketched as a detail in FIG. 1d. The construction is largely equivalent to the embodiment described above, but the one housing part 30 has a bead as its edge 32, and the other housing part 40 has a groove 42a as a complementary edge 42, so that in the assembled state, the edge 26 of the cell 10 is pressed into the groove. The cooling lugs 20, 22 are conversely pressed in large-area fashion between the shoulders 38 and 48. As above, here as well a recess is provided for a possible safety device in the form of a valve.

The housing parts 30, 40 are embodied as rigid and may be of metal, optionally with suitable electrical insulators at electrically critical points, or they may also be of plastic.

The embodiment in FIG. 2 has a preferred device 110 having a plurality of encased cells 100 of the kind described in conjunction with FIGS. 1a-1d, which should be referred to for details of the encased cells 100. As an example, three encased cells 100 are joined together in a stacking direction 56 and are each provided with one thermally insulating intermediate layer 54. On the ends of the stack of encased cells 100, reinforced end plates 50 and 52 are provided, with which the encased cells 100 can be pressed together, when bolts 54, preferably embodied as threaded rods, are guided through the bores 18 (FIG. 1c) and screwed in.

A further embodiment of a preferred device 120 can be seen in FIG. 3, in which a plurality of housed cells 100 are joined together in a stack in the stacking direction 56 and separated by thermally insulating intermediate layers 54. The cooling lugs 20, 22 protrude past the housing parts, not identified here by reference numeral, as is known from FIG. 1. The cooling lugs 20, 22 protruding on the same side of the stack are electrically connected to one another in pairs, except for one cooling lug 20a and 22a each of the respective outer encased cell 100. These cooling lugs are connected to the taps 70 and 72, at which the electrical voltage of the stack is tapped and made available to a user. In this embodiment, the cooling lugs 20, 22 are drilled through, and the corresponding cooling lugs 20, 22 of the neighboring cells are pressed together via insulating spacer elements 66a . . . 66d and 68a . . . 68d, respectively, and a screw fastener extended through them. By means of this pressure, the electrical contact is assured.

The cooling lugs 20, 22 protruding from the housing parts are clamped on each side of the stack in a clamping device 66, 68 for clamping and electrically contacting the cooling lugs 20, 22. To that end, the cooling lugs 20 of the inner encased cells 100 are each clamped together in pairs and between spacer elements 66c and 66b, 66b and 66a. A bolt, not identified by reference numeral, such as a threaded rod, is extended through the spacer elements 66a . . . 66d and screwed together with nuts on the ends. One contact 20a of an outer encased cell 100 is clamped as a single contact between the spacer elements 66c and 66d and can be contacted from outside.

The cooling lugs 22 of the inner encased cells 100 are likewise clamped together in pairs and between spacer elements 68c and 68b, 68b and 68a. One contact 22a of the diametrically opposed outer encased cell 100 is clamped as a single contact between the spacer elements 68a and 66b and can be contacted from outside.

A bolt not identified by reference numeral, such as a threaded rod, is extended through the spacer elements 66a . . . 66d and 68a . . . 68d of the clamping devices 66, 68 and screwed together with nuts on the ends.

It is understood that the stack of the device 120 may also be pressed together with end plates as in FIG. 2.

1. A device having at least one electrochemical cell (10), which is embodied as essentially flat and has laterally protruding cooling lugs (20, 22) for electrical contacting, characterized in that each cell (10) is enclosed between two housing parts (30, 40) that clamp the cell (10) between them with pressure force in at least some regions.

2. The device as defined by claim 1, characterized in that the cell (10) is subjected to pressure force on its edge.

3. The device as defined by claim 1, characterized in that the cooling lugs (20, 22) are subjected to pressure force.

4. The device as defined by claim 1, characterized in that at least one housing part (30, 40) has an indentation (36, 46) for receiving the cell (10).

5. The device as defined by claim 1, characterized in that an encompassing edge (32, 42, 42a) is provided, which subjects the cell (10) to pressure force on its edge.

6. The device as defined by claim 5, characterized in that one housing part (30) has a bead, and the other housing part (40) has a complementary groove.

7. The device as defined by claim 1, characterized in that a shoulder (38, 48) is provided, which subjects a cooling lug (20, 22) to pressure force.

8. The device as defined by claim 1, characterized in that in at least one housing part (30, 40), openings (34a, 44a) for a cooling medium are provided.

9. The device as defined by claim 1, characterized in that in at least one housing part (30, 40), conduits for a cooling medium are provided.

10. The device as defined by claim 1, characterized in that a plurality of encased cells (100) are stacked on one another in a stacking direction (56) and braced against one another.

11. The device as defined by claim 1, characterized in that the cooling lugs (20, 22) protrude from the housing parts (30, 40) and are connected electrically to one another in series and/or parallel.

12. The device as defined by claim 11, characterized in that when there is a plurality of encased cells (100), the cooling lugs (20, 22) on both sides of the housing parts (30, 40) are each clamped in a clamping device (66, 68) for clamping and electrical contacting of the cooling lugs (20, 22) and, except for one cooling lug (20a, 22a) of each of the outer cells (10), at least two cooling lugs (20, 22) on the same side are joined together in the clamping device (66, 68).
